(19) United States
(12) Patent Application Publication
(10) Pub. No.: US 2024/0234812 A1
(43) Pub. Date: Jul. 11, 2024

(54) ELECTROLYTE FOR ANODE-FREE BATTERY

(71) Applicant: GM GLOBAL TECHNOLOGY OPERATIONS LLC

(72) Inventors: Zhe LI, Shanghai (CN); Qili SU, Shanghai (CN); Haijing LIU, Shanghai (CN); Shiguo ZHANG, Changsha (CN); Minghan ZHOU, Changsha (CN)

(73) Assignees: GM GLOBAL TECHNOLOGY OPERATIONS LLC, Detroit, MI (US); GM GLOBAL TECHNOLOGY OPERATIONS LLC, Detroit, MI (US)

(21) Appl. No.: 18/232,899

(22) Filed: Aug. 11, 2023

(30) Foreign Application Priority Data
Jan. 6, 2023 (CN) 202310016687.7

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/0028; H01M 2300/0091

(57) ABSTRACT

An anode-free electrochemical cell that cycles lithium ions includes a positive electrode assembly having a positive current collector and a positive electroactive material layer, a negative current collector that includes a surface configured to receive a negative electroactive material after one or more formation cycles of the anode-free electrochemical cell, and a separating layer disposed between the positive electroactive material layer and the surface of the negative current collector. The separating layer includes an electrolyte that includes greater than or equal to about 20 wt. % to less than or equal to about 99.5 wt. % of a concentrated electrolyte having a lithium salt concentration greater than or equal to about 2 M to less than or equal to about 6 M, and greater than or equal to about 0.5 wt. % to less than or equal to about 80 wt. % of an ionic liquid.

### CROSS-REFERENCE TO RELATED APPLICATIONS

This application claims the benefit and priority of Chinese Application No. 202310016687.7, filed Jan. 6, 2023. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”).

### SUMMARY

This section provides a general summary of the disclosure, and is not a comprehensive disclosure of its full scope or all of its features.

The present disclosure relates to anode-free electrochemical battery cells, and more particularly, to electrolytes for use in anode-free electrochemical battery cells, and methods of making and using the same.

In various aspects, the present disclosure provides an electrolyte for an anode-free electrochemical cell that cycles lithium ions. The electrolyte may include greater than or equal to about 20 wt. % to less than or equal to about 99.5 wt. % of a concentrated electrolyte having a lithium salt concentration greater than or equal to about 2 M to less than or equal to about 6 M, and greater than or equal to about 0.5 wt. % to less than or equal to about 80 wt. % of an ionic liquid. The anode-free electrochemical cell may include a positive electrode and a negative electrode current collector that is configured to receive a negative electroactive material and form a negative electrode after one or more formation cycles of the anode-free electrochemical cell.

In one aspect, the concentrated electrolyte may include a lithium salt selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof.

In one aspect, the lithium salt may include lithium bis(fluorosulfonyl)imide (LiFSI).

In one aspect, the concentrated electrolyte may include a solvent selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof.

In one aspect, the solvent may include dimethoxyethane (DME).

In one aspect, the ionic liquid may include a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N, N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof.

In one aspect, the cation may include 1-butyl-1-methylpyrrolidinium ([Py₁₄]⁺).

In one aspect, the ionic liquid may include an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the anion may include bis(trifluoromethanesulfonyl)imide (TFSI) or difluoro(oxalato)borate (DFOB).

In one aspect, the ionic liquid may include a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof and an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the ionic liquid may include a first anion and a second anion. The first and second anions may be independently selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, a molar ratio of the first anion to the second anion may be greater than or equal to about 0.001:3 to less than or equal to about 3:0.001.

In one aspect, the first anion may include bis(trifluoromethanesulfonyl)imide (TFSI) and the second anion may include difluoro(oxalato)borate (DFOB).

In various aspects, the present disclosure provides an anode-free electrochemical cell that cycles lithium ions. The anode-free electrochemical cell may include a positive electrode assembly that includes a positive current collector and a positive electroactive material layer, a negative current collector that includes a surface configured to receive a negative electroactive material after one or more formation cycles of the anode-free electrochemical cell, and a separating layer disposed between the positive electroactive material layer and the surface of the negative current collector. The negative current collector together with the negative electroactive material may form a negative electrode after the one or more formation cycles. The separating layer may include an electrolyte that includes greater than or equal to about 20 wt. % to less than or equal to about 99.5 wt. % of a concentrated electrolyte having a lithium salt concentration greater than or equal to about 2 M to less than or equal to about 6 M, and greater than or equal to about 0.5 wt. % to less than or equal to about 80 wt. % of an ionic liquid.

In one aspect, the positive electroactive material layer may also include the electrolyte and at least one of the positive current collector and the negative current collector may be in contact with the electrolyte.

In one aspect, the concentrated electrolyte may include a lithium salt and a solvent. The lithium salt may be selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof. The solvent may be selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof.

In one aspect, the ionic liquid may include a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof, and an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the anion may include a first anion and a second anion distinct from the first anion, where a molar ratio of the first anion to the second anion may be greater than or equal to about 0.001:3 to less than or equal to about 3:0.001.

In various aspects, the present disclosure provides an electrolyte for an anode-free electrochemical cell that cycles lithium ions. The electrolyte may include greater than or equal to about 20 wt. % to less than or equal to about 99.5 wt. % of a concentrated electrolyte having a lithium salt concentration greater than or equal to about 2 M to less than or equal to about 6 M, and greater than or equal to about 0.5 wt. % to less than or equal to about 80 wt. % of an ionic liquid. The concentrated electrolyte may include a lithium salt selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof, and a solvent selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof. The ionic liquid may include a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof, and an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the anion may include a first anion and a second anion, where a molar ratio of the first anion to the second anion may be greater than or equal to about 0.001:3 to less than or equal to about 3:0.001.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a schematic illustration of an example anode-free electrochemical battery cell including an electrolyte prepared in accordance with various aspects of the present disclosure;

FIG. 1B is a schematic illustration of the example anode-free electrochemical battery cell of FIG. 1A after cycling in accordance with various aspects of the present disclosure;

FIG. 2 is a graphical illustration demonstrating the Raman shifts of an example anode-free cell including an electrolyte prepared in accordance with various aspects of the present disclosure;

FIG. 3A is a graphical illustration demonstrating the lithium plating/stripping curves of a comparative anode-free cell including a concentrated electrolyte;

FIG. 3B is a graphical illustration demonstrating the lithium plating/stripping curves of a comparative anode-free cell having an electrolyte that includes a concentrated electrolyte and one or more additional salts;

FIG. 3C is a graphical illustration demonstrating the lithium plating/stripping curves of an example anode-free cell including an electrolyte in accordance with various as aspects of the present disclosure;

FIG. 4 is a graphical illustration demonstrating the columbic efficiency of an example anode-free cell including an electrolyte prepared in accordance with various as aspects of the present disclosure;

FIG. 5A are microscopic images of a surface of a negative current collector of a comparative anode-free cell including a concentrated electrolyte;

FIG. 5B are microscopic images of a surface of a negative current collector of a comparative anode-free cell having an electrolyte that includes a concentrated electrolyte and one or more additional salts;

FIG. 5C are microscopic images of a surface of a negative current collector of an example anode-free cell including an electrolyte prepared in accordance with various as aspects of the present disclosure; and

FIG. 6 is a graphical illustration demonstrating the compositional details of a surface of a negative current collector of an example anode-free cell including an electrolyte in accordance with various as aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to anode-free electrochemical battery cells, and more particularly, to electrolytes for use in anode-free electrochemical battery cells, and methods of making and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

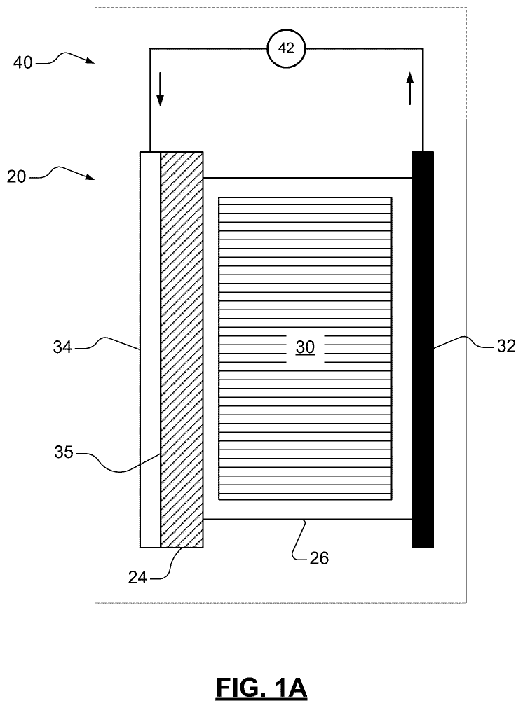

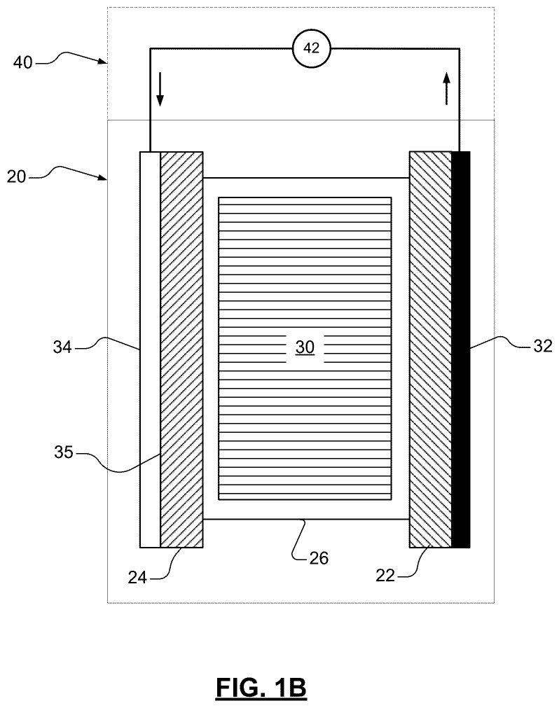

An anode-free electrochemical cell is an electrochemical cell that is initially assembled without a negative electroactive material layer but, during one or more first or formation charges or cycles, lithium metal from a positive electroactive material layer may be deposited (e.g., plated) on to a care negative electrode current collector within an intercalation host material, thereby forming a lithium metal negative electrode layer. An exemplary and schematic illustration of an anode-free electrochemical cell (also referred to as a battery) 20 is shown in FIG. 1A, while an exemplary and schematic illustration of the anode-free electrochemical cell 20 after the one or more formation cycles is shown in FIG. 1B.

As illustrated in FIG. 1A, the anode-free battery 20 includes a first current collector 32 (e.g., negative current collector), a second current collector 34 (e.g., positive current collector), and a separator 26 disposed between the two current collectors 32, 34. In various aspects, positive electroactive material layer (also referred to as a positive electrode) 24 may be disposed between the second current collector 34 and the separator 26, while the separator 26 is in contact with (or disposed near) the first current collector 32.

As illustrated in FIG. 1B, the anode-free battery 20 after the one or more formation cycles includes the first current collector 32, the positive electroactive material layer 24, the separator 26, and the second current collector 32 and also includes a negative electroactive material layer 22, which may include a densely-packed, flat and dendrite-free lithium morphology having a high Coulombic efficiency (e.g., up to about 99.9%) for lithium plating/stripping.

The separator 26 provides electrical separation—prevents physical contact—between the positive electrode 24 and first current collector 32 and the negative electroactive material layer 22 after the one or more formation cycles. The separator 26 also provides a minimal resistance path for internal passage of lithium ions, and in certain instances, related anions, during cycling of the lithium ions. The separator 26, like the positive electrode 24, may be in a solid and/or a liquid form and/or a hybrid thereof. For example, in certain variations, the separator 26 may include an electrolyte 30 that may also be present in the positive electrode 24 and/or the negative electroactive material layer 22. Also, in certain variations, the separator 26 may include a plurality of solid-state electrolyte particles (not shown). Further, in the instance of solid-state batteries and/or semi-solid-state batteries, the positive electrode 24 and/or the negative electroactive material layer 22 may include a plurality of solid-state electrolyte particles (not shown). The electrolyte 30 and/or plurality of solid-state electrolyte particles included in, or defining, the separator 26 may be the same as or different from the electrolyte and/or plurality of solid-state electrolyte particles included in the positive electrode 24 and/or the negative electroactive material layer 22.

The first current collector 32 may be the same as or different from the second current collector 34. The first current collector 32 may be metal foil, metal grid or screen, or expanded metal comprising copper or any other appropriate electrically conductive material known to those of skill in the art. The second current collector 34 may be a metal foil, metal grid or screen, or expanded metal comprising aluminum or any other appropriate electrically conductive material known to those of skill in the art. Although not illustrated, it should be appreciated that, in certain variations, the positive electroactive material layer 24 may be a first positive electroactive material layer, and the cell 20 may include a second positive electroactive material layer disposed on a second side of the second current collector 34 away from the separator 26. The first and second electroactive material layers may be the same or different, and the second current collector 34 together with the one or more electroactive material layers may be referred to as a positive electrode assembly.

In each instance, the first current collector 32 and the second current collector 34 may respectively collect and move free electrons to and from an external circuit 40. For example, an interruptible external circuit 40 and a load device 42 may connect the first current collector 32 and the positive electrode 24 (through the second current collector 34). The battery 20 can generate an electric current during discharge by way of reversible electrochemical reactions that occur when the external circuit 40 is closed (to connect the first current collector 32 and the positive electrode 24) and the first current collector 132 including deposited or plated lithium has a lower potential than the positive electrode 24. The chemical potential difference between the positive electrode 24 and the first current collector 32 drives electrons produced by a reaction, for example, the oxidation of intercalated lithium, at the first current collector 32 through the external circuit 40 toward the positive electrode 24. Lithium ions at the first current collector 32 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the first current collector 32 through the electrolyte 30 across the separator 26 to furnish the first current collector 32 with lithium (e.g., plated lithium as shown in FIG. 1B) for use during the next battery discharge event. As such, a complete discharging event followed by a complete charging event is considered to be a cycle, where lithium ions are cycled between the positive electrode 24 and the first current collector 32. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the first current collector 32, separator 26, positive electrode 24, and/or second current collector 32. The battery 20 shown in FIGS. 1A and 1B includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIGS. 1A and 1B, the positive electrode 24, the separator 26, and/or negative electroactive material layer 22 may each include an electrolyte solution or system 30 inside their pores, capable of conducting lithium ions between the first current collector 32 and the positive electrode 24. In various aspects, the electrolyte 30 includes a concentrated electrolyte (also referred to as a highly concentrated electrolyte (HCE)) and an ionic liquid. For example, the electrolyte 30 may include greater than or equal to about 20 wt. % to less than or equal to about 99.5 wt. %, optionally greater than or equal to about 50 wt. % to less than or equal to about 90 wt. %, and in certain aspects, optionally about 85 wt. %, of the concentrated electrolyte and greater than or equal to about 0.5 wt. % to less than or equal to about 80 wt. %, %, optionally greater than or equal to about 10 wt. % to less than or equal to about 50 wt. %, and in certain aspects, optionally about 15 wt. %, of the ionic liquid. The electrolyte 30 may help to form a solid electrolyte interphase (SEI) layer onto or near the surface of the negative electroactive material layer 22 and/or the first current collector 32.

Generally, concentrated electrolytes may be advantageous for high-powder anode-free batteries because of its high oxidative stability, high thermal stability, low volatility, aluminum anti-corrosion, high carrier density, and most importantly, fast electrode reaction. However, conventional concentrated electrolytes, without the ionic liquid, often endow high-powder anode-free batteries with poor capacity retention and a low coulombic efficiency. The electrolyte 30 in accordance with various aspects of the present disclosure address these shortcomings and provide the concentrated electrolyte in combination with the ionic liquid so as to enhance the cyclability of the battery 20 and the efficiency of lithium plating/stripping.

The concentrated electrolyte in accordance with various aspects of the present disclosure includes a lithium salt and a solvent. For example, the concentrated electrolyte may include greater than or equal to about 2 M to less than or equal to about 6 M, optionally greater than about 2 M to less than or equal to about 6 M, and in certain aspects, optionally about 4 M, of the lithium salt. The lithium salt may include, for example, a lithium cation (Li⁺) and one or more anions selected from the group consisting of: bis(fluorosulfonyl)imide (FSI), hexafluoroarsenate, hexafluorophosphate, tetracyanoboarate (Bison), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl) (BETI), bis(oxalate)borate (BOB), difluoro(oxalato)borate (DFOB), bis(fluoromalonato)borate (BFMB), and combinations thereof. For example, in certain variations, the lithium salt may be selected form the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof.

The solvent dissolves the lithium salt to enable good lithium-ion conductivity. The solvent includes, for example, carbonate solvents (such as dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, and/or 1,2-butylene carbonate), lactones (such as γ-butyrolactone (GBL) and/or δ-valerolactone), nitriles (such as acetonitrile, succinonitrile, glutaronitrile, and/or adiponitrile), sulfones (such as tetramethylene sulfone, ethyl methyl sulfone, vinyl sulfone, phenyl sulfone, 4-fluorophenyl sulfone, and/or benzyl sulfone), ethers (such as dimethoxyethane (DME), triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, and/or 1,4-dioxane), and/or phosphates (such as triethyl phosphate and/or trimethyl phosphate). For example, in certain variations, the solvent may be selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, J-butyrolactone (GBL), ovalerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof.

The ionic liquid includes a cation and an anion. In certain variations, the cation may be selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof. The anion included in the ionic liquid may be the same as or different from the anion included in the liquid salt. For example, in certain variations, the anion included in the ionic liquid may be selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In certain variations, the electrolyte 30 may include one or more ionic liquids. For example, the electrolyte 30 may include a first ionic liquid and a second ionic liquid, where a molar ratio of the first ionic liquid to the second ionic liquid may be greater than or equal to about 0:3 to less than or equal to about 3:0, optionally greater than or equal to about 0.001:3 to less than or equal to about 3:0.001, and in certain aspects, optionally about 1:2. The first and second ionic liquids may each include a cation independently selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and an anion independently selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

With renewed reference to FIG. 1, the separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. For example, in certain variations, the separator 26 may be a polyolefin-based separator including, for example, polyacetylene, polypropylene (PP), and/or polyethylene (PE); a cellulose separator including, for example, polyvinylidene fluoride (PVDF) membrane and/or a porous polyimide membrane; and/or a high-temperature-stable separators (e.g., separators stable at temperatures greater than or equal to about 150° C.) including, for example, polyimide (PI) nanofiber-based nonwovens, nano-sized aluminum oxide (Al₂O₃) and poly(lithium 4-styrenesulfonate)-coated polyethylene membrane, silicon oxide (SiO₂) coated polyethylene (PE) separator, co-polyimide-coated polyethylene separators, polyetherimides (PEI) (bisphenol-aceton diphthalic anhydride (BPADA) and para-phenylenediamine) separator, expanded polytetrafluoroethylene reinforced polyvinylidenefluoride-hexafluoropropylene separator. In each instance, the separator 26 may have an average thickness greater than or equal to about 1 micrometer (μm) to less than or equal to about 50 μm, and in certain instances, optionally greater than or equal to about 1 μm to less than or equal to about 20 μm; and the electrolyte 30 may wet greater than or equal to about 5 vol. % to less than or equal to about 100 vol. %, and in certain aspects, optionally greater than or equal to about 70 vol. % to less than or equal to about 100 vol. %, of a total porosity of the separator 26.

In various aspects, the porous separator 26 and/or the electrolyte 30 disposed in the porous separator 26 as illustrated in FIGS. 1A and 1B may be replaced with a solid-state electrolyte (“SSE”) and/or semi-solid electrolyte (e.g., gel) that functions as both an electrolyte and a separator. For example, the solid-state electrolyte and/or semi-solid-state electrolyte may be disposed between the positive electrode 24 and the negative electroactive material layer 22 and/or the first current collector 32. The solid-state electrolyte and/or semi-solid-state electrolyte facilitates transfer of lithium ions, while mechanically separating and providing electrical insulation between the positive electrodes 24 and the negative electroactive material layer 22 and/or the first current collector 32.

The solid-state electrolyte and/or semi-solid electrolyte may include a plurality of solid-state electrolyte particles. In certain variations, the electrolyte 30 may at least partially fill voids (e.g., interparticle porosity) between the solid-state electrolyte particles defining the separator 26. In each variation, the solid-state electrolyte particles may include, for example, oxide-based solid-state particles (such as garnet type solid-state particles (e.g., Li₇La₃Zr₂O₁₂ (LLZO)), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1)), metal-doped or aliovalent-substituted oxide solid-state particles (such as aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSiₓP_{3-y}O₁₂ (where 0<x<2 and 0<y<3)), sulfide-based solid-state particles (such as Li₂S—P₂S₅ systems (e.g., Li₃PS₄, Li₇P₃S₁₁, and Li_{9.6}P₃S₁₂), Li₂S—SnS₂ systems (e.g., Li₄SnS₄), Li₂S—P₂S₅-MOx systems (where M is selected from the group consisting of: P, Sn, Mg, Zn, and combinations thereof and 0<x<2), Li₂S—P₂S₅-MSx systems (where M is selected from the group consisting of: P, Sn, Mg, Zn, and combinations thereof and 0<x<2), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}As_{0.166}S₄, LiI—Li₄SnS₄, and/or Li₄SnS₄), nitride-based solid-state particles (such as Li₃N, Li₇PN₄, and/or LiSi₂N₃), hydride-based solid-state particles (such as LiBH₄, LiBH₄—LiX (where X=Cl, Br, or I), LiNH₂, Li₇NH, LiBH₄—LiNH₂, and/or Li₃AlH₆), halide-based solid-state particles (such as Li₃YCl₆, Li₃InCl₆, Li₃YBr₆, LiI, Li₇CdC₁₄, Li₂MgCl₄, LiCdl₄, Li₇ZnI₄, and/or Li₃OCl), and/or borate-based solid-state particles (Li₂B₄O₇ and/or Li₇O—B₂O₃—P₂O₅).

The semi-solid electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The liquid electrolyte may be like the electrolyte 30 detailed above. In certain variations, the semi-solid or gel electrolyte may also be found in the positive electrode 24.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores (e.g., interparticle porosity) of the positive electrode 24. In certain variations, the positive electrode 24 may include a plurality of solid-state electrolyte particles. In each instance, the positive electrode 24 may have a thickness greater than or equal to about 10 micrometers (μm) to less than or equal to about 400 micrometers (μm).

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electrode 24 may be a composite electrode including a combination of positive electroactive materials. For example, the positive electrode 24 may include a first positive electroactive material and a second positive electroactive material. A ratio of the first positive electroactive material to the second positive electroactive material may be greater than or equal to about 5:95 to less than or equal to about 95:5. In certain variations, the first and second positive electroactive materials may be independently selected from one or more layered oxides, one or more olivine-type oxides, one or more monoclinic-type oxides, one or more spinel-type oxide, one or more tavorite, or combinations thereof. By way of example, in certain variations, the positive electroactive material may include LiCoO₂, LiMn₂O₄, LiNi_{0.5}Mn_{1.5}O₄, and/or LiV₂(PO₄)₃.

In various aspects, the positive electrode 24 may further include an electronically conductive material (i.e. conductive additive) that provides an electron conductive path and/or a polymeric binder material that improves the structural integrity of the positive electrode 24. For example, the positive electrode 24 may include greater than or equal to about 30 wt. % to less than or equal to about 98 wt. % of the positive electroactive material; greater than or equal to about 0 wt. % to less than or equal to about 50 wt. %, and in certain aspects, optionally greater than 0 wt. % to less than or equal to about 50 wt. %, of a plurality of solid-state electrolyte particles; greater than or equal to about 0 wt. % to less than or equal to about 30 wt. %, and in certain aspects, optionally greater than 0 wt. % to less than or equal to about 30 wt. %, of the electrolyte 30; greater than or equal to about 0 wt. % to less than or equal to about 30 wt. %, and in certain aspects, optionally greater than 0 wt. % to less than or equal to about 30 wt. %, of the conductive additive; and greater than or equal to about 0 wt. % to less than or equal to about 20 wt. %, and in certain aspects, greater than 0 wt. % to less than or equal to about 20 wt. %, of the binder.

Example polymeric binders include polyimide, polyamic acid, polyamide, polysulfone, polyvinylidene difluoride (PVdF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

Certain features of the current technology are further illustrated in the following non-limiting examples.

### Example 1

Example batteries and battery cells may be prepared in accordance with various aspects of the present disclosure.

For example, an example cell 210 may include an example electrolyte prepared in accordance with various aspects of the present disclosure. The example electrolyte may include a concentrated electrolyte and an ionic liquid. For example, the example electrolyte may include about 85 wt. % of the concentrated electrolyte and about 15 wt. % of the ionic liquid. The concentrated electrolyte may include, for example, lithium bis(fluorosulfonyl)imide (LiFSI) as the lithium salt and dimethoxyethane (DME) as the solvent. The concentrated electrolyte may include about 4 M of the lithium bis(fluorosulfonyl)imide (LiFSI). The ionic liquid may include, for example, a first ionic liquid and a second ionic liquid, where a molar ratio of the first ionic liquid to the second ionic liquid is about 1:3. The first ionic liquid may include, for example, Py14[TFSI]. The second ionic liquid may include, for example, Py14[DFOB]. The example cell may have a lithium-ion conductivity of about 7.2 mS/cm at about 25° C.

A first comparative cell 220 may include a first comparative electrolyte. The first comparative electrolyte may include a concentrated electrolyte that includes lithium bis(fluorosulfonyl)imide (LiFSI) as the lithium salt and dimethoxyethane (DME) as the solvent, where the lithium salt has a concentration of about 4M. The first comparative cell 220 may have an electrical conductivity of about 6.9 mS/cm at about 25° C.

A second comparative cell 230 may include a second comparative electrolyte. The second comparative electrolyte may include about 90 wt. % of a concentrated electrolyte and about 10 wt. % of an additional lithium salt. The additional lithium salt may include a first lithium salt and a second lithium salt. For example, the second comparative electrolyte may include about 5 wt. % of lithium difluoro(oxalato)borate (LiDFOB) and about 5 wt. % of lithium bis(trifluoromethanesulfonyl)imide (LiTFSI). The second comparative cell 230 may have an electrical conductivity of about 7.1 mS/cm at about 25° C.

The first example cell 210 and the first and second comparative cells 220, 230 may each include a positive electrode assembly (that includes a positive current collector and a positive electroactive material layer that includes LiMn_{0.7}Fe_{0.3}PO₄), a negative current collector, and a separator that physical separates the positive electrode assembly and the negative current collector.

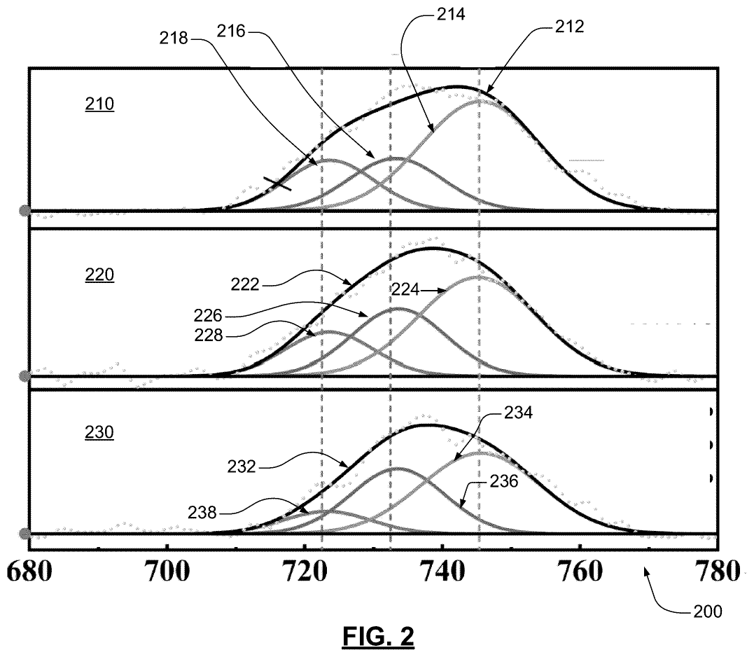

FIG. 2 is a graphical illustration that represents Raman shifts for the example cell 210 as compared to the first comparative cell 220 and also the second comparative cell 230, where the x-axis 200 represents Raman shift (cm-1). Line 212 represents the over-all spectrum for the example cell 210, while line 214 represents aggregates of anions, lithium ions, and solvents, line 216 represents contact ion pairs, and line 218 represents free bis(fluorosulfonyl)imide (FSI). From the illustration, it is recognized that the introduction of the ionic liquid can increase the ratio of free anions (e.g., bis(fluorosulfonyl)imide (FSI)) in the electrolyte and the free anions help to facilitate the formation of a solid electrolyte interphase (SEI) layer with high lithium fluoride (LiF) content.

The example cell 210, as well as the first and second comparative cells 220, 230 may be discharged at 0.2 mA/cm² for about 3 hours, followed by charging to about 1.2V at about 0.5 mA/cm².

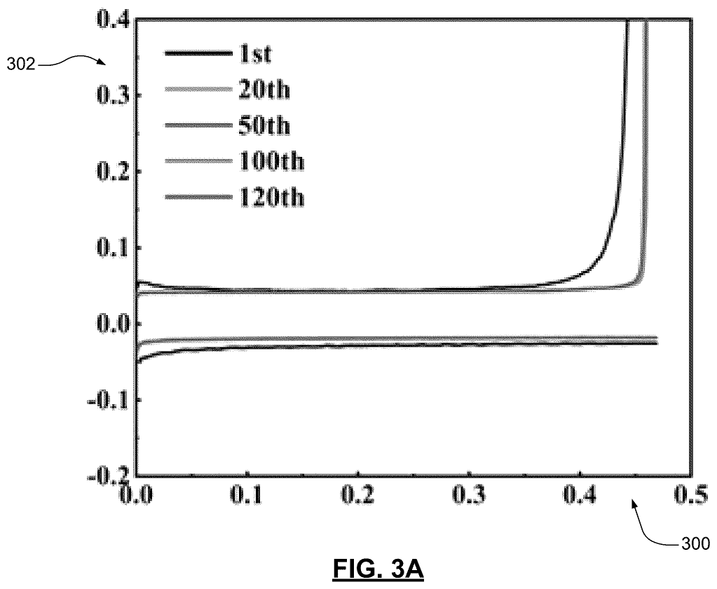

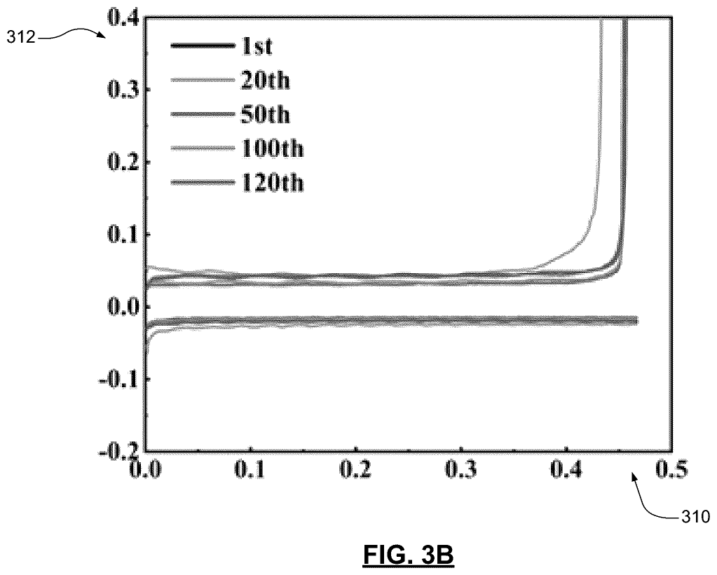

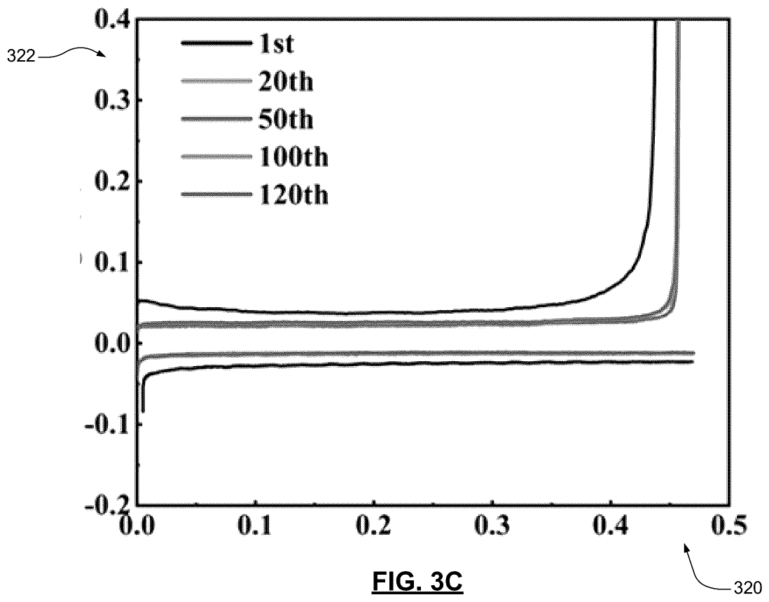

FIG. 3A is a graphical illustration that represents the lithium plating/stripping curves of the first comparative cell 220, where the x-axis 300 represents areal capacity (mAh/cm²), and the y-axis 302 represents voltage (V); FIG. 3B is a graphical illustration that represents the lithium plating/stripping curves of the second comparative cell 230, where the x-axis 310 represents areal capacity (mAh/cm²), and the y-axis 312 represents voltage (V); and FIG. 3C is a graphical illustration that represents the lithium plating/stripping curves of the example cell 210, where the x-axis 320 represents areal capacity (mAh/cm²), and the y-axis 322 represents voltage (V). As illustrated, the example cell 210 has a lower voltage polarization, which indicates a more conductive solid electrolyte interface (SEI) layer as compared to the first comparative cell 220 and the second comparative cell 230.

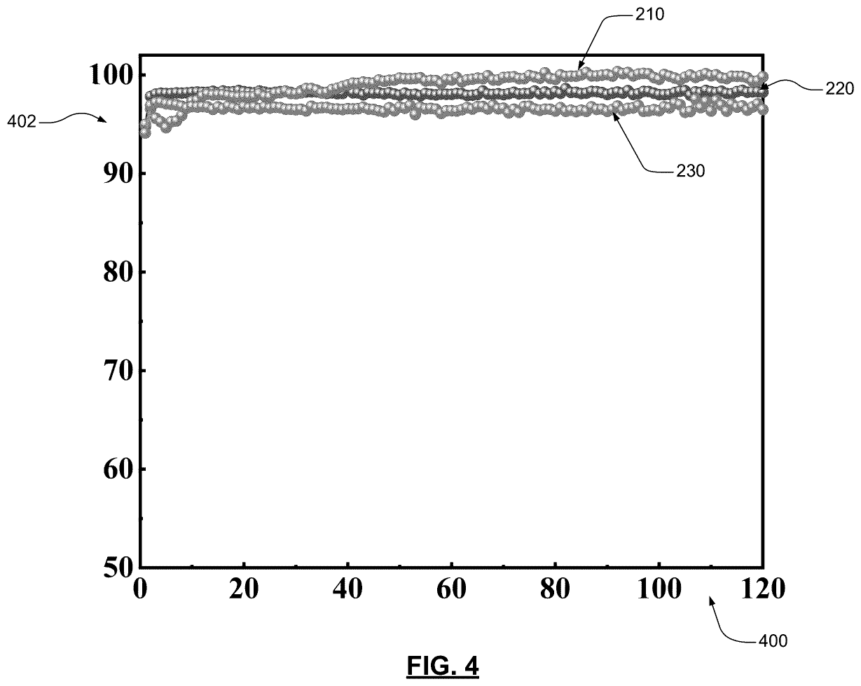

FIG. 4 is a graphical illustration demonstrating the columbic efficiency of the example cell 210 as compared to the comparative cells 220, 230, where the x-axis 400 represents cycle number, and the y-axis 402 represents columbic efficiency (%). As illustrated, the example cell 210 has improved Columbic efficiency as compared to the first and second comparative cells 220, 230. For example, the example cell 210 has a Columbic efficiency of about 99.9%, while the first comparative cell 220 has a Columbic efficiency of about 98% and the second comparative cell 230 has a Columbic efficiency of about 96%.

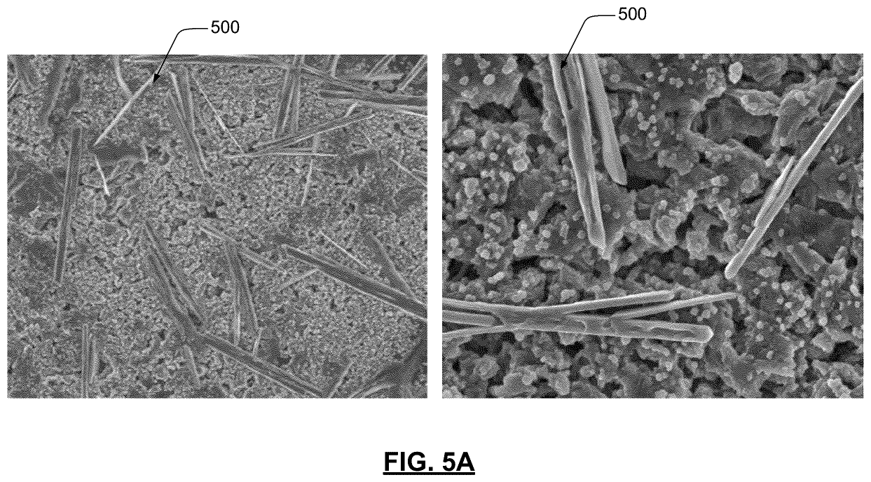

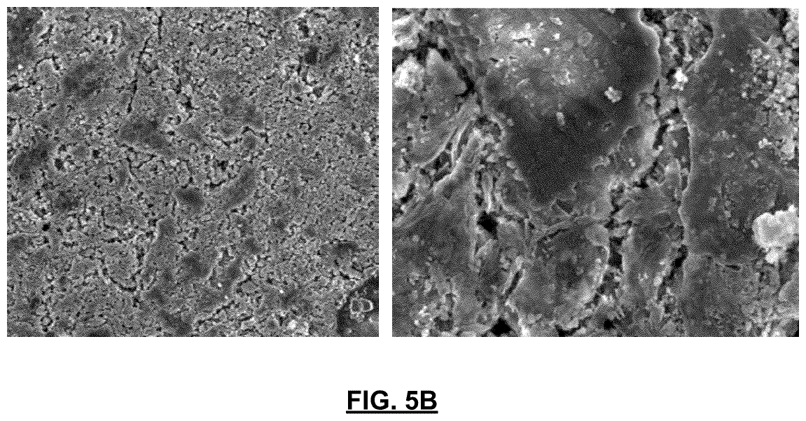

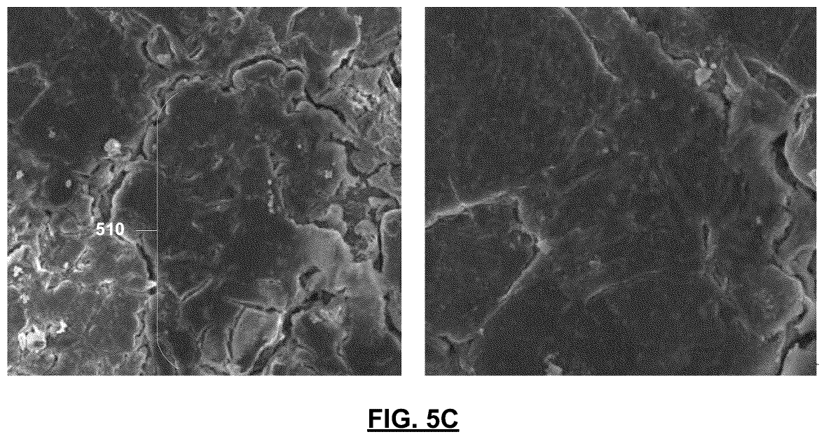

FIG. 5A are microscopic images of a surface of a negative electrode current collector of the first example cell 220 after about 120 cycles; FIG. 5B are microscopic images of a surface of a negative electrode current collector of the second example cell 230 after about 120 cycles; and FIG. 5C are microscopic images of a surface of a negative electrode current collector of the example cell 210 about 120 cycles. As illustrated, the first comparative cell 220 includes substantially lithium dendrite formation (e.g., dendrites 500) after about 120 cycles, while the second comparative cell 230 is dendrite-free and loose after about 120 cycles and example cell 210 includes a substantially smooth lithium mosaic comprised of densely packed lithium domains 510 having diameters up to about 20 micrometers (μm).

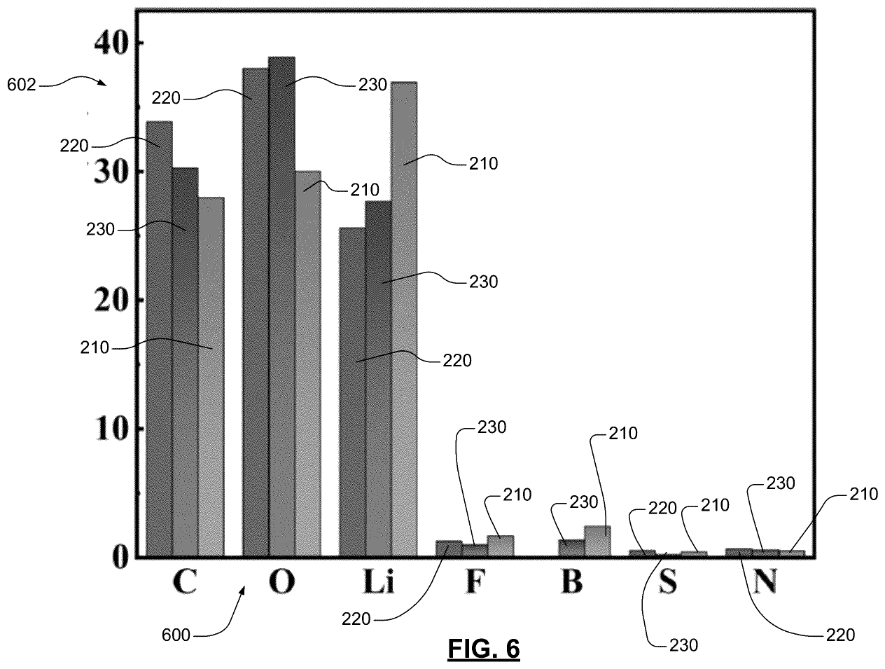

FIG. 6 is a graphical illustration demonstrating the compositional ratios of a surface of a negative electrode current collector of the example cell 210 as compared to the comparative cells 220, 230 after about 120 cycles, where the elements are represented on the x-axis 600, and the y-axis 602 represents content ratios. The reduction in the amount of carbon (C) and oxygen (O) for the example cell 210 as compared to the comparative cells 220, 230 indicates that the solvent decomposition has been suppress, and the higher amount of lithium (Li) and fluoride (F) may be beneficial to enhance the cyclability of the example cell 210 and also the efficiency of lithium plating/stripping.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrolyte for an anode-free electrochemical cell that cycles lithium ions, the electrolyte comprising:
greater than or equal to about 20 wt. % to less than or equal to about 99.5 wt. % of a concentrated electrolyte having a lithium salt concentration greater than or equal to about 2 M to less than or equal to about 6 M; and
greater than or equal to about 0.5 wt. % to less than or equal to about 80 wt. % of an ionic liquid, wherein the anode-free electrochemical cell comprises a positive electrode and a negative electrode current collector configured to receive a negative electroactive material and form a negative electrode after one or more formation cycles of the anode-free electrochemical cell.

2. The electrolyte of claim 1, wherein the concentrated electrolyte comprises a lithium salt selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof.

3. The electrolyte of claim 2, wherein the lithium salt comprises lithium bis(fluorosulfonyl)imide (LiFSI).

4. The electrolyte of claim 1, wherein the concentrated electrolyte comprises a solvent selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof.

5. The electrolyte of claim 4, wherein the solvent comprises dimethoxyethane (DME).

6. The electrolyte of claim 1, wherein the ionic liquid comprise a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof.

7. The electrolyte of claim 6, wherein the cation comprises 1-butyl-1-methylpyrrolidinium ([Py₁₄]⁺).

8. The electrolyte of claim 1, wherein the ionic liquid comprises an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

9. The electrolyte of claim 8, wherein the anion comprises bis(trifluoromethanesulfonyl)imide (TFSI) or difluoro(oxalato)borate (DFOB).

10. The electrolyte of claim 1, wherein the ionic liquid comprises a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

11. The electrolyte of claim 1, wherein the ionic liquid comprises a first anion and a second anion, the first and second anions independently selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

12. The electrolyte of claim 11, wherein a molar ratio of the first anion to the second anion is greater than or equal to about 0.001:3 to less than or equal to about 3:0.001.

13. The electrolyte of claim 11, wherein the first anion comprises bis(trifluoromethanesulfonyl)imide (TFSI) and the second anion comprises difluoro(oxalato)borate (DFOB).

14. An anode-free electrochemical cell that cycles lithium ions, the anode-free electrochemical cell comprising:
a positive electrode assembly comprising a positive current collector and a positive electroactive material layer;
a negative current collector comprising a surface configured to receive a negative electroactive material after one or more formation cycles of the anode-free electrochemical cell, wherein the negative current collector together with the negative electroactive material forms a negative electrode after the one or more formation cycles; and
a separating layer disposed between the positive electroactive material layer and the surface of the negative current collector, the separating layer comprising an electrolyte that comprises:
greater than or equal to about 20 wt. % to less than or equal to about 99.5 wt. % of a concentrated electrolyte having a lithium salt concentration greater than or equal to about 2 M to less than or equal to about 6 M; and
greater than or equal to about 0.5 wt. % to less than or equal to about 80 wt. % of an ionic liquid.

15. The anode-free electrochemical cell of claim 14, wherein the positive electroactive material layer also comprises the electrolyte and at least one of the positive current collector and the negative current collector is in contact with the electrolyte.

16. The anode-free electrochemical cell of claim 14, wherein the concentrated electrolyte comprises a lithium salt selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof; and
a solvent selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof.

17. The anode-free electrochemical cell of claim 14, wherein the ionic liquid comprises a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

18. The anode-free electrochemical cell of claim 17, wherein the anion comprises a first anion and a second anion distinct from the first anion, wherein a molar ratio of the first anion to the second anion is greater than or equal to about 0.001:3 to less than or equal to about 3:0.001.

19. An electrolyte for an anode-free electrochemical cell that cycles lithium ions, the electrolyte comprising:
greater than or equal to about 20 wt. % to less than or equal to about 99.5 wt. % of a concentrated electrolyte having a lithium salt concentration greater than or equal to about 2 M to less than or equal to about 6 M, wherein the concentrated electrolyte comprises:
a lithium salt selected from the group consisting of: lithium bis(fluorosulfonyl)imide (LiFSI), lithium hexafluoroarsenate, lithium hexafluorophosphate, lithium tetracyanoboarate, lithium perchlorate, lithium tetrafluoroborate, lithium cyclo-difluoromethane-1,1-bis(sulfonyl)imide, lithium bis(trifluoromethanesulfonyl)imide (LiTFSI), lithium bis(perfluoroethanesulfonyl), lithium bis(oxalate)borate (LiBOB), lithium difluoro(oxalato)borate (LiDFOB), lithium bis(fluoromalonato)borate, and combinations thereof, and
a solvent selected from the group consisting of: dimethoxyethane (DME), dimethyl carbonate (DMC), diethyl carbonate (DEC), ethyl methyl carbonate (EMC), ethylene carbonate (EC), propylene carbonate (PC), glycerol carbonate, vinylene carbonate, fluoroethylene carbonate, 1,2-butylene carbonate, γ-butyrolactone (GBL), δ-valerolactone, acetonitrile, succinonitrile, glutaronitrile, adiponitrile, tetramethylene sulfone, ethyl methyl sulfone, vinyl sulfone, phenyl sulfone, 4-fluorophenyl sulfone, benzyl sulfone, triethylene glycol dimethylether (triglyme, G3), tetraethylene glycol dimethylether (tetraglyme, G4), hydrofluoroether, bis(2,2,2-trifluoroethyl) ether (BTFE), 1,1-dimethoxyl propane, 1,4-dioxane, triethyl phosphate, trimethyl phosphate, and combinations thereof; and
greater than or equal to about 0.5 wt. % to less than or equal to about 80 wt. % of an ionic liquid comprising:
a cation selected from the group consisting of: Li(triglyme) ([Li(G3)]⁺), Li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N—N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁₁₄]⁺), triisobutylmethylphosphonium ([P₁₁₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

20. The electrolyte of claim 19, wherein the anion comprises a first anion and a second anion, wherein a molar ratio of the first anion to the second anion is greater than or equal to about 0.001:3 to less than or equal to about 3:0.001.
